(19) United States
(12) Patent Application Publication
(10) Pub. No.: US 2014/0281838 A1
(43) Pub. Date: Sep. 18, 2014

(54) SENSOR AND SENSING METHOD

(71) Applicant: SONY CORPORATION, Minato-ku (JP)

(72) Inventor: Oichi Kumagai, Kanagawa (JP)

(73) Assignee: SONY CORPORATION, Minato-ku (JP)

(21) Appl. No.: 14/353,395

(22) PCT Filed: Dec. 4, 2012
(86) PCT No.: PCT/JP2012/081307

§ 371 Date: Apr. 22, 2014

(30) Foreign Application Priority Data
Dec. 14, 2011 (JP) 2011-272995

(51) Int. Cl. G06F 11/10

(52) U.S. Cl. CPC G06F 11/10
USPC 714/776

(57) ABSTRACT

There is provided a sensor including an interface block that converts a sensing signal outputted from a sensing block into a predetermined data format which is beforehand defined to output to another device. The interface block includes an error correction information generation unit that generates error correction information used for correction of an error in the data format, a data generation determination unit that determines whether or not predetermined data to be inserted in the data format is being generated, and an operation control unit that controls operation of the error correction information generation unit on the basis of a determination result of whether or not the predetermined data to be inserted in the data format is being generated.

### TECHNICAL FIELD

The present technology relates to a sensor and a sensing method, and in particular, relates to a censor and a sensing method enabling to suppress increase of power consumption due to implementing a circuit for a countermeasure against transmission errors without the influence on operation of a device.

### BACKGROUND ART

Along with enhancement of picture quality and increase of a frame rate in an image sensor, a transmission capacity of data is increasing to be required for an interface between the image sensor and a DSP (Digital Signal Processor) processing an image captured by the image sensor.

In order to satisfy such a requirement, for example, a technique is employed for enhancing a clock frequency for the interface, reducing a voltage for the signal, and the like. However, according to this technique, difficulty in generation of sampling timing on the DSP side increases, causing the correct transmission of data to be difficult.

As a standard for increasing the transmission capacity between chips, standards such as PCI Express and Serial ATA are available. In PCI Express and Serial ATA, a high transmission capacity is attained by enhancing the performance of a CDR (Clock Data Recovery) circuit and an equalizer. Moreover, as an interface between chips for a mobile phone, the MIPI (Mobile Industry Processor Interface) standard is available.

### CITATION LIST

### Non-Patent Literature

Non-Patent Literature 1: Serial ATA: High Speed Serialized AT Attachment Revision 1.0a 7 Jan. 2003

### SUMMARY OF INVENTION

### Technical Problem

However, the above-mentioned standards involve many redundant functions to an interface between an image sensor and a DSP from such a reason that they are prepared as interface standards for more general purposes like an interface between CPUs (Central Processing Units). Supposed that these standards would be employed for the interface between an image sensor and a DSP, functions not required for the interface between an image sensor and a DSP also have to be implemented, causing a circuit area, power consumption and costs for implementation to increase.

In particular, the influence of implementing a circuit for a countermeasure against transmission errors is significant. For example, when, as a circuit for the circuit for a countermeasure against transmission errors, a circuit that generates ECC (Error Correcting Code)/CRC (Cyclic Redundancy Check) being codes for transmission error correction is provided, power consumption in the relevant circuit is a load.

The present technology is disclosed in view of such circumstances and increase of power consumption due to implementing a circuit for a countermeasure against transmission errors can be suppressed without the influence on operation of a device.

### Solution to Problem

According to an embodiment of the present technology, there is provided a sensor including an interface block that converts a sensing signal outputted from a sensing block into a predetermined data format which is beforehand defined to output to another device. The interface block includes an error correction information generation unit that generates error correction information used for correction of an error in the data format, a data generation determination unit that determines whether or not predetermined data to be inserted in the data format is being generated, and an operation control unit that controls operation of the error correction information generation unit on the basis of a determination result of whether or not the predetermined data to be inserted in the data format is being generated.

The operation control unit may control the operation of the error correction information generation unit by controlling supply of a clock to the error correction information generation unit.

The sensor further includes an error-correction-information necessity determination unit that determines whether or not the error correction information is necessary in the data format. In a case where the error-correction-information necessity determination unit determines that the error correction information is necessary while the error correction information generation unit is operating, and when the data generation determination unit determines that the predetermined data to be inserted in the data format is not being generated, the operation control unit causes the operation of the error correction information generation unit to be suspended.

The sensor further includes an error-correction-information necessity determination unit that determines whether or not the error correction information is necessary in the data format. In a case where the error-correction-information necessity determination unit determines that the error correction information is necessary while the error correction information generation unit is suspended, and when the data generation determination unit determines that the predetermined data to be inserted in the data format is not being generated, the operation control unit causes the operation of the error correction information generation unit to be started.

The data generation determination unit may determine whether or not a packet is being generated, the packet storing data corresponding to the sensing signal which is in a predetermined unit and is transmitted according to the data format.

According to an embodiment of the present technology, there is provided a sensing method for a sensor which includes an interface block that converts a sensing signal outputted from a sensing block into a predetermined data format which is beforehand defined to output to another device, the interface block including: an error correction information generation unit that generates error correction information used for correction of an error in the data format, a data generation determination unit that determines whether or not predetermined data to be inserted in the data format is being generated, and an operation control unit that controls operation of the error correction information generation unit on the basis of a determination result of whether or not the predetermined data to be inserted in the data format is being generated, the method including the steps of: in the data generation determination unit, determining whether or not the predetermined data to be inserted in the data format is being generated, and in the operation control unit, controlling the operation of the error correction information generation unit on the basis of the determination result of whether or not the predetermined data to be inserted in the data format is being generated.

According to the aspect of the present technology, the error correction information used for the correction of the error in the data format is generated, whether or not the predetermined data to be inserted in the data format is being generated is determined, and the operation of the error correction information generation unit is controlled on the basis of the determination result of whether or not the predetermined data to be inserted in the data format is being generated.

### Advantageous Effects of Invention

According to the present technology, increase of power consumption due to implementing a circuit for a countermeasure against transmission errors can be suppressed without the influence on operation of a device.

### BRIEF DESCRIPTION OF DRAWINGS

FIG. 1 is a block diagram illustrating an exemplary configuration of a CMOS image sensor to which the present technology is applied.

FIG. 2 is a diagram for explaining a conventional example of a part of the CMOS image sensor 10 illustrated in FIG. 1 more in detail.

FIG. 3 is a diagram illustrating an exemplary configuration of a frame generated by a sensor digital block 22.

FIG. 4 is a diagram illustrating an exemplary configuration of a packet illustrated in FIG. 3.

FIG. 5 is a diagram illustrating an exemplary configuration according to an embodiment of the present technology and a diagram for explaining a part of the CMOS image sensor illustrated in FIG. 1 more in detail.

FIG. 6 is a flowchart for explaining an example of clock supply control processing.

FIG. 7 is a flowchart for explaining another example of the clock supply control processing.

### DESCRIPTION OF EMBODIMENTS

Hereafter, embodiments of the technology disclosed herein are described with reference to the drawings.

FIG. 1 is a block diagram illustrating an exemplary configuration of a CMOS image sensor to which the present technology is applied. This CMOS image sensor 10 is provided, for example, in a digital camera or the like and captures images.

In the example of the figure, the CMOS image sensor 10 is constituted of a PLL/PHY block 21, a sensor digital block 22 and a pixel block 23.

The PLL/PHY block 21 is primarily constituted of a phase-locked loop (PLL (Phase-locked loop)) and frequency dividers, and generates a signal at a predetermined frequency supplied to a clock generation unit inside the sensor digital block 22.

The sensor digital block 22 is configured, for example, to generate data of frames in a beforehand defined format on the basis of signals outputted from the pixel block to supply to a not-shown DSP (Digital Signal Processor) or the like. The frames generated by the sensor digital block 22 are supplied, for example, to a DSP processing an image captured by the CMOS image sensor.

The pixel block 23 is configured to include photoelectric transducers and the like and to output signals corresponding to the light obtained by the capturing to the sensor digital block 22.

FIG. 2 is a diagram for explaining a part of the CMOS image sensor 10 illustrated in FIG. 1 more in detail. Namely, in FIG. 2, detailed configurations of the PLL/PHY block 21 and the sensor digital block 22 in FIG. 1 are illustrated.

Incidentally, the exemplary configuration illustrated in FIG. 2 is a conventional one and an exemplary configuration according to the present technology is mentioned later.

As illustrated in FIG. 2, the PLL/PHY block 21 is constituted of a PLL unit 31 and a PHY analog unit 32. Moreover, the sensor digital block 22 is constituted of a PHY logic unit 34 and a sensor control unit 35.

In this example, a signal outputted from an oscillator 41 (“×16”) of the PLL unit 31 is supplied to a frequency divider 42 (“Div 1/2/4”) and a frequency divider 51 (“Div 1/4”) of the PHY analog unit 32. Moreover, a signal outputted from the frequency divider 42 is supplied to a frequency divider 52-1 to a frequency divider 52-8 (Div 1/5) of the PHY analog unit 32 via enable 43 (“Enable”).

Moreover, a signal outputted from the frequency divider 51 of the PHY analog unit 32 is supplied to a frequency divider 61-1 (“Div 1/2”) of a clock generation unit 33. Signals outputted from the frequency divider 52-1 to the frequency divider 52-8 of the PHY analog unit 32 are supplied to a terminal 74-1 to a terminal 74-8 of the PHY logic unit 34, respectively. Furthermore, the signal outputted from the frequency divider 52-1 of the PHY analog unit 32 is also supplied to a terminal 73-3 of the PHY logic unit 34. The signal supplied to the terminal 73-3 is referred to as a PHY logic clock.

A signal outputted from the frequency divider 61-1 of the clock generation unit 33 is supplied to a frequency divider 61-2, and in addition, to a terminal 73-1 of the PHY logic unit 34 via enable 62-1. The signal supplied to the terminal 73-1 is referred to as a link logic clock. A signal outputted from the frequency divider 61-2 of the clock generation unit 33 is supplied to a terminal 73-2 of the PHY logic unit 34 via enable 62-2. The signal supplied to the terminal 73-2 is referred to as a gated clock.

When generating data of a frame in a beforehand defined format on the basis of a signal outputted from the pixel block, a CRC circuit 71 of the PHY logic unit 34 is configured to generate a CRC (Cyclic Redundancy Check) included in header information of a packet stored in the relevant frame.

When generating the data of the frame in the beforehand defined format on the basis of the signal outputted from the pixel block, an ECC circuit 72 of the PHY logic unit 34 is configured to generate an ECC (Error Correcting Code) included in the header information of the packet stored in the relevant frame.

FIG. 3 is a diagram illustrating an exemplary configuration of a frame generated by the sensor digital block 22. This frame is used, for example, for transmitting image data of one frame between the CMOS image sensor 10 and the DSP.

Individual data from “Start Code” illustrated at the left end in FIG. 3 to “Idle Code” illustrated at the right end in the figure is stored in the relevant frame. Furthermore, in this frame, a packet 101 is stored. The packet 101 is constituted of “Packet Header”, “Data Payload” and “Footer”.

As header information of the packet 101, “Packet Header” is configured.

As a payload of the packet 101, “Data Payload” is configured. In the payload of the packet 101, for example, data of pixels constituting one line out of the data of the image captured by the CMOS image sensor 10 is stored. For example, transmission of the whole data of the image of one frame is to be performed using a plurality of packets.

As footer information of the packet 101, “Footer” is configured and optionally added (there is a case where “Footer” is not added).

FIG. 4 is a diagram illustrating an exemplary configuration of the packet 101 illustrated in FIG. 3. As illustrated in the figure, “Packet Header” of the packet 101 is constituted of data with 24 bytes in which a combination of “Header” with 6 bytes and a CRC with 2 bytes is repeated 3 times to be inserted. Furthermore, the data with 18 bytes except the top 6 bytes of “Packet Header” is used for an ECC.

Herein, the CRCs are, for example, values calculated as error detection codes for the data inserted as “Data Payload”. Moreover, in “Header”, for example, information for identifying the position of the line in the data of the image which line corresponds to the data inserted as “Data Payload” is included.

Moreover, in the example of FIG. 4, “Footer” which is an option is added to the packet 101 and a CRC with 2 bytes is inserted as “Footer”.

The CRCs illustrated in FIG. 4 are generated by the CRC circuit 71 in FIG. 2 and the ECC illustrated in FIG. 4 is generated by the ECC circuit 72 in FIG. 2.

Any of the CRC circuit 71 and the ECC circuit 72 of the PHY logic unit 34 in FIG. 2 is a circuit for a countermeasure against transmission errors and operates on the basis of the PHY logic clock. Namely, the CRC circuit 71 and the ECC circuit 72 are configured to operate upon supply of the PHY logic clock to the terminal 73-3 of the PHY logic unit 34.

Moreover, in FIG. 2, 8 pieces of enable provided corresponding to the terminal 74-1 to the terminal 74-8 are illustrated. Furthermore, a terminal 75-1 to a terminal 75-8 are provided to output the clock supplied to the terminal 74-1 to the terminal 74-8 along with the outputs of these 8 pieces of enable. For example, a transmission path between the CMOS image sensor 10 and the DSP are to be constituted of signal lines connected to the terminal 75-1 to the terminal 75-8 of the PHY logic unit 34. This transmission path is also referred to as lane (Lane).

The sensor control unit 35 in FIG. 2 is, for example, a unit controlling transmission and reception of control signals to/from a not-shown user interface. A three-line serial communication circuit 81 is configured to output the control signals corresponding to parameters supplied from the user interface to supply to the PHY logic unit 34.

As mentioned above, the CRC circuit 71 and the ECC circuit 72 of the PHY logic unit 34 operate upon supply of the PHY logic clock to the terminal 73-3.

However, there is also a case where a CRC or an ECC is not required in the data outputted by the sensor digital block 22. In the case of the configuration illustrated in FIG. 2, even in such a case, the PHY logic clock is always to be supplied to the terminal 73-3. When the CRC circuit 71 and the ECC circuit 72 operate, power consumption is to increase due to occurrence of a switching current, a leak current and the like. A technology has been being expected for effectively suppressing such power consumption.

Therefore, in the present technology, power consumption is effectively suppressed when a CRC or an ECC is not required. FIG. 5 is a diagram illustrating an exemplary configuration according to an embodiment of the present technology and a diagram for explaining a part of the CMOS image sensor 10 illustrated in FIG. 1 more in detail.

In FIG. 5, parts corresponding to those in FIG. 2 are provided with the same signs, have the similar functions as in the case of FIG. 2 and the detailed description of those is omitted.

In the example of FIG. 5, different from the case of FIG. 2, the PHY logic unit 34 is provided with a power saving control circuit 76. Moreover, in the example of FIG. 5, different from the case of FIG. 2, the sensor control unit 35 is provided with a clock control circuit 82.

Furthermore, in the example of FIG. 5, different from the case of FIG. 2, the clock generation unit 33 is provided with enable 62-3 and enable 62-4.

In the case of the configuration in FIG. 5, the CRC circuit 71 is configured to operate on the basis of a control clock supplied via the enable 62-3. Namely, upon supply of the control clock from the enable 62-3, the CRC circuit 71 operates, and upon suspension of the supply of the control clock from the enable 62-3, the CRC circuit 71 is also suspended.

Moreover, in the case of the configuration in FIG. 5, the ECC circuit 72 is configured to operate on the basis of a control clock supplied via the enable 62-4. Namely, upon supply of the control clock from the enable 62-4, the ECC circuit 72 operates, and upon suspension of the supply of the control clock from the enable 62-4, the ECC circuit 72 is also suspended.

The power saving control circuit 76 outputs a control signal corresponding to a process in the PHY logic unit 34 to the clock control circuit 82, as mentioned later, on the basis of the control signal supplied from the three-line serial communication circuit 81.

The power saving control circuit 76 determines whether or not the CRC and the ECC are required in the data outputted by the sensor digital block 22, for example, on the basis of the control signal supplied from the three-line serial communication circuit 81. When it is determined that the CRC or the ECC is not required, the power saving control circuit 76 operates as follows.

The power saving control circuit 76 is configured, for example, to monitor the process in the PHY logic unit 34. Namely, the power saving control circuit 76 is configured to detect whether or not the generation of the packet 101, for example, illustrated in FIG. 4 has been completed in the PHY logic unit 34.

Namely, it is detected whether or not the generation of the CRCs and the ECC illustrated in FIG. 4 has been completed and the generation of the packet 101 has been completed. As mentioned above, the CRCs illustrated in FIG. 4 are, for example, values calculated as error detection codes of the data inserted as “Data Payload”, and the ECC is constituted of a combination of 3 CRCs and 2 pieces of “Header”.

Accordingly, when the CRCs and the ECC illustrated in FIG. 4 are generated by the CRC circuit 71 and the ECC circuit 72, all the generation of the data to be inserted in one packet 101 is regarded as having been completed and the generation of the one packet is to be completed. After that, when all the acquisition of data to be inserted as “Data Payload” of a next packet and the like has been done, the CRC circuit 71 and the ECC circuit 72 are to start the generation of CRCs and ECC for the next packet.

The power saving control circuit 76 is configured to, for example, to detect whether or not the packet 101 is being generated, and when the packet 101 is being generated, to output a control signal representing this (control signal A) to the clock control circuit 82. Moreover, when the packet 101 is not being generated (for example, in the state of waiting for supply of a signal corresponding to data to be inserted in the next packet), the power saving control circuit 76 is configured to output a control signal representing this (control signal B) to the clock control circuit 82.

On the other hand, for example, when it is determined that the CRCs and the ECC are required in the data outputted by the sensor digital block 22 on the basis of the control signal supplied from the three-line serial communication circuit 81, the power saving control circuit 76 operates as follows.

Namely, when it is determined that the CRCs and the ECC are required, the power saving control circuit 76 is configured to output a control signal representing that the CRCs and the ECC are required (control signal C) to the clock control circuit 82.

The clock control circuit 82 controls the enable 62-3 and the enable 62-4 on the basis of the control signals outputted from the power saving control circuit 76.

When the control signal representing that the packet 101 is being generated (control signal A) is outputted from the power saving control circuit 76, the clock control circuit 82 controls and causes the enable 62-3 and the enable 62-4 to supply the control clock to the CRC circuit 71 and the ECC circuit 72. Moreover, when the control signal representing that the packet 101 is not being generated (control signal B) is outputted from the power saving control circuit 76, the clock control circuit 82 controls and causes the enable 62-3 and the enable 62-4 to suspend the supply of the control clock to the CRC circuit 71 and the ECC circuit 72.

Furthermore, when the control signal representing that the CRCs and the ECC are required (control signal C) is outputted from the power saving control circuit 76, the clock control circuit 82 controls and causes the enable 62-3 and the enable 62-4 to supply the control clock to the CRC circuit 71 and the ECC circuit 72.

By doing as above, for example, in the case where the CRC circuit 71 and the ECC circuit 72 operate, when the control signal representing that the CRCs or the ECC is not required is supplied from the three-line serial communication circuit 81, the supply of the control clock can be configured to be suspended after waiting for the generation of the packet 101.

For example, when the supply of the control clock is suspended to suspend the CRC circuit 71 and the ECC circuit 72 while the packet 101 is being generated, the data inserted in the packet 101 suffers inconsistency. In the case of such inconsistency, the process in the DSP is not to be terminated normally. Due to this, it is required that the supply of the control clock is suspended after waiting for the generation of the packet 101.

In the above-mentioned example, it is supposed as a premise that the CRC circuit 71 and the ECC circuit 72 are caused to be suspended in the state where the CRC circuit 71 and the ECC circuit 72 operate, whereas there is also a case where the CRC circuit 71 and the ECC circuit 72 are caused to operate in the state where the CRC circuit 71 and the ECC circuit 72 are suspended.

For example, also in the case where the CRC circuit 71 and the ECC circuit 72 are caused to operate in the state where the CRC circuit 71 and the ECC circuit 72 are suspended, the supply of the control clock is needed to be started after waiting for the generation of the packet 101 likewise. This is because, when the supply of the control clock is started to cause the CRC circuit 71 and the ECC circuit 72 to operate while the packet 101 is being generated, the data inserted in the packet 101 is to suffer inconsistency and the process in the DSP is not to be terminated normally.

For example, when the CRC circuit 71 and the ECC circuit 72 have been already suspended, the power saving control circuit 76 determines whether or not the CRCs and the ECC are required in the data outputted by the sensor digital block 22, for example, on the basis of the control signal supplied from the three-line serial communication circuit 81. When the CRCs and the ECC are required, the power saving control circuit 76 operates as follows.

The power saving control circuit 76 is configured, for example, to detect whether or not the packet 101 is being generated, and when the packet 101 is being generated, to output a control signal representing this (control signal D) to the clock control circuit 82. Moreover, when the packet 101 is not being generated, the power saving control circuit 76 is configured to output a control signal representing this (control signal E) to the clock control circuit 82.

On the other hand, when it is determined that the CRCs or the ECC is not required in the data outputted by the sensor digital block 22, for example, on the basis of the control signal supplied from the three-line serial communication circuit 81, the power saving control circuit 76 operates as follows.

Namely, when it is determined that the CRCs and the ECC are required, the power saving control circuit 76 is configured to output a control signal representing that the CRCs or the ECC is not required (control signal F) to the clock control circuit 82.

When the control signal representing that the packet 101 is being generated (control signal D) is outputted from the power saving control circuit 76, the clock control circuit 82 controls and causes the enable 62-3 and the enable 62-4 not to supply the control clock to the CRC circuit 71 and the ECC circuit 72. Moreover, when the control signal representing that the packet 101 is not being generated (control signal E) is outputted from the power saving control circuit 76, the clock control circuit 82 controls and causes the enable 62-3 and the enable 62-4 to start the supply of the control clock to the CRC circuit 71 and the ECC circuit 72.

Furthermore, when the control signal representing that the CRCs or the ECC is not required (control signal F) is outputted from the power saving control circuit 76, the clock control circuit 82 controls and causes the enable 62-3 and the enable 62-4 not to supply the control clock to the CRC circuit 71 and the ECC circuit 72.

By doing as above, in the case where the CRC circuit 71 and the ECC circuit 72 have been already suspended, for example, when the control signal representing that the CRCs and the ECC are required is supplied from the three-line serial communication circuit 81, the supply of the control clock can be started after waiting for the generation of the packet 101.

According to the present technology, the supply of the control clock can be suspended with appropriate timing as mentioned above and the CRC circuit 71 and the ECC circuit 72 can be suspended without the influence on operation of the DSP, for example. Hence, according to the present technology, increase of power consumption due to implementing a circuit for a countermeasure against transmission errors can be suppressed without the influence on operation of a device.

Next, referring to a flowchart in FIG. 6, an example of clock supply control processing in the CMOS image sensor to which the present technology is applied is described. This processing is performed, for example, while the CRC circuit 71 and the ECC circuit 72 are operating.

In step S21, the power saving control circuit 76 checks the control signal, for example, supplied from the three-line serial communication circuit 81.

In step S22, as a result of the process in step S21, the power saving control circuit 76 determines whether or not the CRC and the ECC are required in the data outputted by the sensor digital block 22.

In step S22, when it is determined that the CRC or the ECC is not required, the process is put forward to step S23.

In step S23, the power saving control circuit 76 determines whether or not the packet 101 is being generated.

In step S23, when it is determined that the packet 101 is being generated, the process in step S23 is repeated. In addition, at this stage, the power saving control circuit 76 outputs the control signal representing that the packet 101 is being generated to the clock control circuit 82 as mentioned above. Then, when the control signal representing that the packet 101 is being generated is outputted from the power saving control circuit 76, the clock control circuit 82 controls and causes the enable 62-3 and the enable 62-4 to supply the control clock to the CRC circuit 71 and the ECC circuit 72.

In step S23, when it is determined that the packet 101 is not being generated, the process is put forward to step S24. In addition, at this stage, the power saving control circuit 76 outputs the control signal representing that the packet 101 is not being generated to the clock control circuit 82 as mentioned above.

In step S24, the clock control circuit 82 controls and causes the enable 62-3 and the enable 62-4 to suspend the supply of the control clock to the CRC circuit 71 and the ECC circuit 72.

Thus, in step S25, the CRC circuit 71 and the ECC circuit 72 are suspended.

On the other hand, in step S22, as the result of the process in step S21, when it is determined that the CRC and the ECC are required in the data outputted by the sensor digital block 22, the processes in step S23 to step S25 are skipped. In addition, at this stage, the power saving control circuit 76 outputs the control signal representing that the CRC and the ECC are required to the clock control circuit 82 as mentioned above. Moreover, when the control signal representing that the CRC and the ECC are required is outputted from the power saving control circuit 76, the clock control circuit 82 controls and causes the enable 62-3 and the enable 62-4 to supply the control clock to the CRC circuit 71 and the ECC circuit 72.

By doing as above, the clock supply control processing while the CRC circuit 71 and the ECC circuit 72 are operating is performed.

Next, referring to a flowchart in FIG. 7, another example of the clock supply control processing in the CMOS image sensor to which the present technology is applied is described. This processing is performed, for example, when the CRC circuit 71 and the ECC circuit 72 have been already suspended.

In step S41, the power saving control circuit 76 checks the control signal, for example, supplied from the three-line serial communication circuit 81.

In step S42, as the result of the process in step S41, the power saving control circuit 76 determines whether or not the CRC and the ECC are required in the data outputted by the sensor digital block 22.

In step S42, when it is determined that the CRC and the ECC are required, the process is put forward to step S43.

In step S43, the power saving control circuit 76 determines whether or not the packet 101 is being generated.

In step S43, when it is determined that the packet 101 is being generated, the process in step S43 is repeated. In addition, at this stage, the power saving control circuit 76 outputs the control signal representing that the packet 101 is being generated to the clock control circuit 82 as mentioned above. Then, when the control signal representing that the packet 101 is being generated is outputted from the power saving control circuit 76, the clock control circuit 82 controls and causes the enable 62-3 and the enable 62-4 not to supply the control clock to the CRC circuit 71 and the ECC circuit 72.

In step S43, when it is determined that the packet 101 is not being generated, the process is put forward to step S44. In addition, at this stage, the power saving control circuit 76 outputs the control signal representing that the packet 101 is not being generated to the clock control circuit 82 as mentioned above.

In step S44, the clock control circuit 82 controls and causes the enable 62-3 and the enable 62-4 to start the supply of the control clock to the CRC circuit 71 and the ECC circuit 72.

Thus, in step S45, the CRC circuit 71 and the ECC circuit 72 are caused to operate.

On the other hand, in step S42, as the result of the process in step S41, when the CRC or the ECC is not required in the data outputted by the sensor digital block 22, the processes in step S43 to step S45 are skipped. In addition, at this stage, the power saving control circuit 76 outputs the control signal representing that the CRC or the ECC is not required to the clock control circuit 82 as mentioned above. Moreover, when the control signal representing that the CRC or the ECC is not required is outputted from the power saving control circuit 76, the clock control circuit 82 controls and causes the enable 62-3 and the enable 62-4 not to supply the control clock to the CRC circuit 71 and the ECC circuit 72.

By doing as above, the clock supply control processing when the CRC circuit 71 and the ECC circuit 72 have been already suspended is performed.

Incidentally, the series of processes mentioned above in the specification do not only include processes chronologically performed in the described order but also include processes which are not necessarily performed chronologically but performed in parallel or individually.

Furthermore, embodiments of the present technology are not limited to the above-mentioned embodiments but various modifications may occur without departing from the spirit and scope of the present technology.

Additionally, the present technology may also be configured as below.
(1)
   A sensor including
   an interface block that converts a sensing signal outputted from a sensing block into a predetermined data format which is beforehand defined to output to another device,
   wherein the interface block includes
      an error correction information generation unit that generates error correction information used for correction of an error in the data format,
      a data generation determination unit that determines whether or not predetermined data to be inserted in the data format is being generated, and
      an operation control unit that controls operation of the error correction information generation unit on the basis of a determination result of whether or not the predetermined data to be inserted in the data format is being generated.
(2)
   The sensor according to (1),
   wherein the operation control unit controls the operation of the error correction information generation unit by controlling supply of a clock to the error correction information generation unit.
(3)
   The sensor according to (1) or (2), further including
   an error-correction-information necessity determination unit that determines whether or not the error correction information is necessary in the data format,
   wherein in a case where the error-correction-information necessity determination unit determines that the error correction information is necessary while the error correction information generation unit is operating, and when the data generation determination unit determines that the predetermined data to be inserted in the data format is not being generated, the operation control unit causes the operation of the error correction information generation unit to be suspended.
(4)
   The sensor according to any one of (1) to (3), further including
   an error-correction-information necessity determination unit that determines whether or not the error correction information is necessary in the data format,
   wherein in a case where the error-correction-information necessity determination unit determines that the error correction information is necessary while the error correction information generation unit is suspended, and when the data generation determination unit determines that the predetermined data to be inserted in the data format is not being generated, the operation control unit causes the operation of the error correction information generation unit to be started.
(5)
   The sensor according to any one of (1) to (4),
   wherein the data generation determination unit determines whether or not a packet is being generated, the packet storing data corresponding to the sensing signal which is in a predetermined unit and is transmitted according to the data format.
(6)
   A sensing method for a sensor which includes
   an interface block that converts a sensing signal outputted from a sensing block into a predetermined data format which is beforehand defined to output to another device, the interface block including
      an error correction information generation unit that generates error correction information used for correction of an error in the data format,
      a data generation determination unit that determines whether or not predetermined data to be inserted in the data format is being generated, and
      an operation control unit that controls operation of the error correction information generation unit on the basis of a determination result of whether or not the predetermined data to be inserted in the data format is being generated, the method including steps of:
   in the data generation determination unit, determining whether or not the predetermined data to be inserted in the data format is being generated; and
   in the operation control unit, controlling the operation of the error correction information generation unit on the basis of the determination result of whether or not the predetermined data to be inserted in the data format is being generated.

### REFERENCE SIGNS LIST

10 CMOS image sensor
21 PLL/PHY block
22 Sensor digital block
23 Pixel block
31 PLL unit
32 PHY analog unit
34 PHY logic unit
35 Sensor control unit
62-1 to 62-4 Enable
71 CRC circuit
72 ECC circuit
73 Power saving control circuit
81 Three-line serial communication circuit
82 Clock control circuit

1. A sensor comprising
an interface block that converts a sensing signal outputted from a sensing block into a predetermined data format which is beforehand defined to output to another device,
wherein the interface block includes
an error correction information generation unit that generates error correction information used for correction of an error in the data format,
a data generation determination unit that determines whether or not predetermined data to be inserted in the data format is being generated, and
an operation control unit that controls operation of the error correction information generation unit on the basis of a determination result of whether or not the predetermined data to be inserted in the data format is being generated.

2. The sensor according to claim 1,
wherein the operation control unit controls the operation of the error correction information generation unit by controlling supply of a clock to the error correction information generation unit.

3. The sensor according to claim 1, further comprising
an error-correction-information necessity determination unit that determines whether or not the error correction information is necessary in the data format,
wherein in a case where the error-correction-information necessity determination unit determines that the error correction information is necessary while the error correction information generation unit is operating, and when the data generation determination unit determines that the predetermined data to be inserted in the data format is not being generated, the operation control unit causes the operation of the error correction information generation unit to be suspended.

4. The sensor according to claim 1, further comprising
an error-correction-information necessity determination unit that determines whether or not the error correction information is necessary in the data format,
wherein in a case where the error-correction-information necessity determination unit determines that the error correction information is necessary while the error correction information generation unit is suspended, and when the data generation determination unit determines that the predetermined data to be inserted in the data format is not being generated, the operation control unit causes the operation of the error correction information generation unit to be started.

5. The sensor according to claim 1,
wherein the data generation determination unit determines whether or not a packet is being generated, the packet storing data corresponding to the sensing signal which is in a predetermined unit and is transmitted according to the data format.

6. A sensing method for a sensor which includes
an interface block that converts a sensing signal outputted from a sensing block into a predetermined data format which is beforehand defined to output to another device, the interface block including
an error correction information generation unit that generates error correction information used for correction of an error in the data format,
a data generation determination unit that determines whether or not predetermined data to be inserted in the data format is being generated, and
an operation control unit that controls operation of the error correction information generation unit on the basis of a determination result of whether or not the predetermined data to be inserted in the data format is being generated, the method comprising steps of:
in the data generation determination unit, determining whether or not the predetermined data to be inserted in the data format is being generated; and
in the operation control unit, controlling the operation of the error correction information generation unit on the basis of the determination result of whether or not the predetermined data to be inserted in the data format is being generated.
